(19) United States
(12) Patent Application Publication
(10) Pub. No.: US 2011/0138023 A1
(43) Pub. Date: Jun. 9, 2011

(54) PROGRAMMING METHOD OF NETWORK NODES IN SENSOR NETWORK AND OPERATING METHOD OF SENSOR NETWORK

(76) Inventors: Seung-ki Hong, Daejeon (KR); Jong-Arm Jun, Daejeon (KR); Cheol Sig Pyo, Daejeon (KR); Sang-Hun Lee, Seoul (KR); Lynn Choi, Seoul (KR)

(21) Appl. No.: 12/952,664

(22) Filed: Nov. 23, 2010

(30) Foreign Application Priority Data
Dec. 9, 2009 (KR) 10-2009-0121662

(51) Int. Cl. G06F 15/177

(52) U.S. Cl. 709/220

(57) ABSTRACT

Provided is a programming method of network nodes in sensor network. The programming method receives a code to be programmed in the network nodes. The programming method determines the kind of the received code. The programming method selects a programming scheme according to the determined kind of the code. The programming method programs the received code in the network nodes based on the selected programming scheme.

### CROSS-REFERENCE TO RELATED APPLICATIONS

This U.S. non-provisional patent application claims priority under 35 U.S.C. §119 of Korean Patent Application No. 10-2009-0121662, filed on Dec. 9, 2009, the entire contents of which are hereby incorporated by reference.

### BACKGROUND OF THE INVENTION

The present invention disclosed herein relates to a network, and more particularly, to a programming method of network nodes in sensor network and an operating method of sensor network.

With the advance of network technology, research is actively being made on a Ubiquitous Sensor Network (USN). The USN enables to collect and establish information on things and environments in real time.

The network nodes of a sensor network drive various codes. The sensor network is configured, and then a portion of the codes may be newly installed in the network nodes, be updated, or be deleted. Generally, since sensor network nodes use a limited power source, a programming method is required which decreases power consumption and traffic load when codes are programmed in the sensor network.

### SUMMARY OF THE INVENTION

The present invention provides a programming method of network nodes in sensor network, which decreases power consumption and traffic load.

Embodiments of the present invention provide a programming method of network nodes in sensor network including: receiving a code to be programmed into the network nodes; determining the kind of the received code; selecting a programming scheme according to the determined kind of the code; and programming the received code into the network nodes based on the selected programming scheme.

In some embodiments, the determining of the kind of the received code may include determining whether the received code is required in all the network nodes of the sensor network.

In other embodiments, the determining of the kind of the received code may include determining whether the received code is a code that is always driven.

In still other embodiments, the determining of the kind of the received code may include determining whether driving timings of the received code are synchronized.

In even other embodiments, the determining of the kind of the received code may include determining whether the received code is installed within a reference time.

In yet other embodiments, the selecting of a programming scheme may include selecting a code dissemination scheme.

In further embodiments, the programming of the received code may include performing the selected code dissemination scheme based on a connected dominating set.

In still further embodiments, the selecting of a programming scheme may include selecting a selective code dissemination scheme.

In even further embodiments, the programming of the received code may include: transmitting information of the received code to the network nodes; transmitting the received code to selected network nodes, which transmit a response signal corresponding to the transmitted information of the received code, among the network nodes; and programming the transmitted code into the selected network nodes.

In yet further embodiments, the selecting of a programming scheme may include selecting a code acquisition scheme.

In much further embodiments, the programming of the received code may include: transmitting the received code to a network node which transmits code demand among the network nodes; and programming the transmitted code into a corresponding network node.

In still much further embodiments, the programming of the received code may further include programming the transmitted code into at least one network node, when the transmitted code is required in the at least one network node of network nodes on a path through which the transmitted code is transmitted.

In even much further embodiments, when the received code is required in all the network nodes of the sensor network and driving timings of the received code are synchronized, the received code may be programmed into all the network nodes through a code dissemination scheme.

In yet much further embodiments, when the received code is required in a portion of the network nodes and driving timings of the received code are synchronized, code information of the received code may be transmitted to the network nodes, and the received code may be programmed into network nodes which respond to the transmitted code information.

In yet further embodiments, when driving timings of the received code are not synchronized, the received code may be programmed into a network node which demands the received code among the network nodes.

In much further embodiments, when driving timings of the received code are not synchronized and the received code is installed within a reference time, the received code may be stored in some network nodes among the network nodes, the stored code may be transmitted from the some network nodes to a network node demanding the received code and be programmed.

In other embodiments of the present invention, an operating method of sensor network includes: receiving a code to be programmed into network nodes of the sensor network; detecting kind information of the received code; and programming the received code into the network nodes based on the detected kind information.

In some embodiments, the programming of the received code may include: selecting a programming scheme based on the detected kind information; and programming the received code into the network nodes based on the selected programming scheme.

In other embodiments, the selecting of a programming scheme may include selecting any one of a first programming scheme which programs the received code into the network nodes, a second programming scheme which programs the received code into network nodes responding to metadata transmission of the received code among the network nodes, and a third programming scheme which programs the received code into a network node demanding the received code among the network nodes.

In still other embodiments, the selecting of a programming scheme may include selecting the programming scheme based on whether the received code is required in all the network nodes of the sensor network, whether the received code is always driven, whether driving timings of the received code are synchronized and whether the received code is installed within a reference time.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a block diagram illustrating a network node according to an embodiment of the present invention;

FIG. 2 is a block diagram illustrating a sensor network which includes the network node in FIG. 1;

FIG. 3 is a flow chart illustrating a method for programming the network nodes of the sensor network in FIG. 2;

FIG. 4 is a table for describing the kinds of codes;

FIG. 5 is a table showing an embodiment of division based on the kinds of codes in FIG. 4;

FIG. 6 is a block diagram illustrating programming schemes according to an embodiment of the present invention;

FIG. 7 is a block diagram illustrating the CDS of the sensor network in FIG. 2;

FIG. 8 is a flow chart illustrating a CDS-based code dissemination scheme in FIG. 6;

FIG. 9 is a block diagram illustrating the first and second groups of the network nodes of the sensor network in FIG. 1;

FIG. 10 is a flow chart for describing a selective code dissemination scheme in FIG. 6;

FIG. 11 is a flow chart for describing an operation of the network node when a selective code dissemination scheme is performed;

FIG. 12 is a flow chart for describing a code acquisition scheme in FIG. 6;

FIG. 13 is a flow chart for describing an operation of the network node 100 which relays a code when the code acquisition scheme in FIG. 12 is performed;

FIG. 14 is a table for describing a programming scheme which is selected based on the kinds of codes in FIG. 4;

FIG. 15 is a flow chart for describing an operation in which a sink node sets cache information when a code to be programmed is a dynamic asynchronous and real time code;

FIG. 16 is a flow chart for describing an operation in which the network node caches a code when a code to be programmed is a dynamic asynchronous and real time code;

FIG. 17 illustrates an embodiment of a sensor system including the sensor network in FIG. 2; and

FIG. 18 illustrates another embodiment of a sensor system including the sensor network in FIG. 2.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, it will be described about an exemplary embodiment of the present invention in conjunction with a sensor network. However, the scope and spirit of the present invention are not limited to the sensor network.

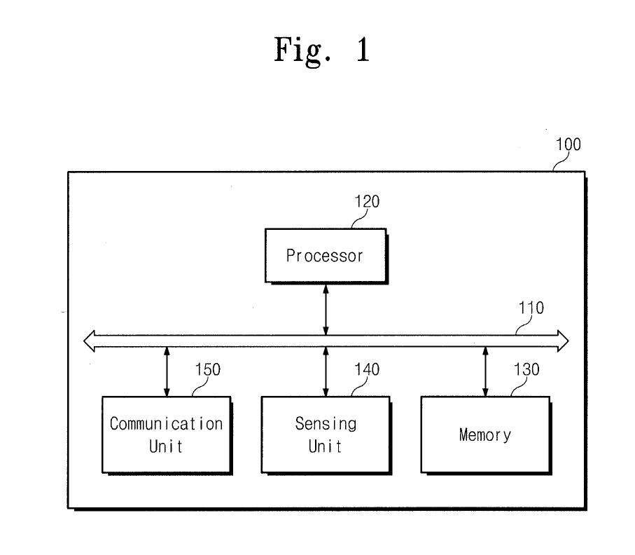

FIG. 1 is a block diagram illustrating a network node 100 according to an embodiment of the present invention.

Referring to FIG. 1, a network node 100 according to an embodiment of the present invention includes an internal bus 110, a processor 120, a memory 130, a sensing unit 140, and a communication unit 150.

The internal bus 110 provides a channel between the elements of the network node 100.

The processor 120 is connected to the internal bus 110. The processor 120 controls various operations of the network node 100. The processor 120 drives various codes that control the network node 100. For example, the processor 120 drives various codes such as applications and an Operating System (OS). For example, the processor 120 drives the codes through the memory 130.

The memory 130 is connected to the internal bus 110. The memory 130 operates as the operation memory of the network node 100. For example, the memory 130 operates as the cache memory or buffer memory of the network node 100. For example, the memory 130 operates in response to a code that is driven in the processor 120.

The sensing unit 140 is connected to the internal bus 110. The sensing unit 140 senses the features of an external environment. For example, the sensing unit 140 senses the temperature, humidity, sound, brightness, motion, pressure and gravity of an external environment. For example, the sensing unit 140 operates in response to a code that is driven in the processor 120.

The communication unit 150 is connected to the internal bus 110. The communication unit 150 provides an external network node and an external communication means. For example, the communication unit 150 includes a transmitter and a receiver. For example, the communication unit 150 operates in response to a code that is driven in the processor 120.

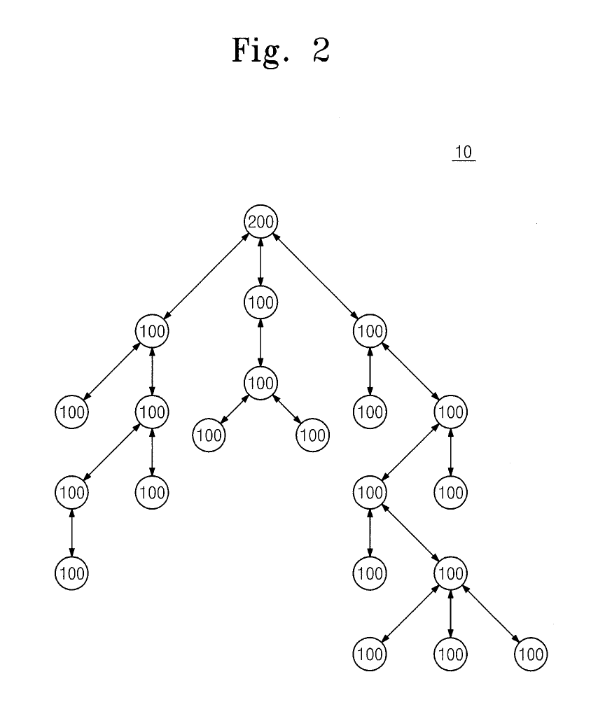

FIG. 2 is a block diagram illustrating a sensor network which includes the network node 100 in FIG. 1.

Referring to FIG. 2, the sensor network 10 includes network nodes 100 and a sink node 200. Except for that in which the sensing unit 140 is not provided, the sink node 200 is configured identically to the network node 100 that has been described above with reference to FIG. 1. Accordingly, a detailed description on the sink node 200 will be omitted.

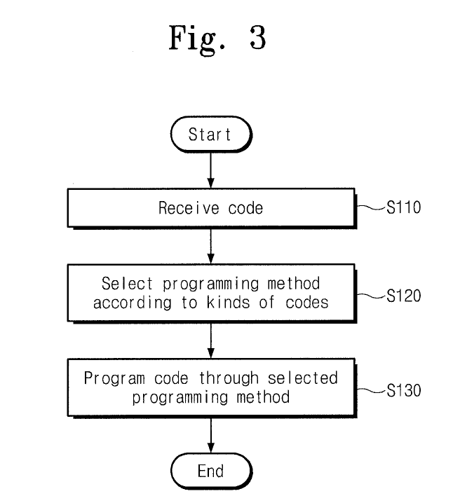

FIG. 3 is a flow chart illustrating a method for programming the network nodes 100 of the sensor network 10 in FIG. 2.

Referring to FIGS. 2 and 3, a code is received in operation S110. For example, a code to be programmed in the network nodes 100 is received in the sensor network 10. For example, a code to be programmed in the network nodes 100 is received in the sink node 200.

For example, a received code may be one that is newly installed in the network nodes 100. For example, a received code may be one to which a code pre-installed in the network nodes 100 is updated. For example, a received code may be one in which a code pre-installed in the network nodes 100 is deleted. Hereinafter, an operation of programming a code in the network nodes 100 or the sensor network 10 may include installation, update and deletion.

A programming scheme is selected according to the kinds of codes in operation S120. For example, when a code to be programmed is generated (for example, received), the kind of a code is detected from the generated code. For example, the generated code may include information on the kind of code. For example, when a code is received, information on the kind of code may also be received together.

A received code is programmed through the selected programming scheme in operation 5130. Since a programming scheme is selected according to the kinds of codes and a code is programmed through the selected programming scheme, a programming scheme that is optimized according to the kinds of codes may be applied. Accordingly, power consumption and traffic load based on code programming can be minimized.

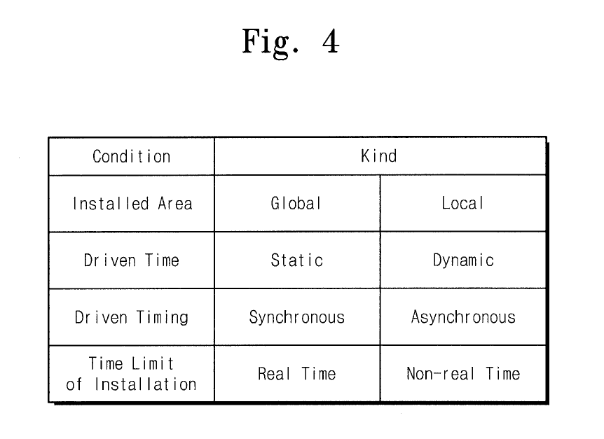

FIG. 4 is a table for describing the kinds of codes.

Referring to FIG. 4, a code is divided into a global code and a local code according to an area in which the code is installed. For example, when a code is required in all the network nodes 100 of the sensor network 10, i.e., when the code should be programmed in all the network nodes 100, the code is divided into a global code. When a code is required in a portion of the network nodes 100 of the sensor network 10, i.e., when the code should be programmed in a portion of the network nodes 100, the code is divided into a local code.

A code is divided into a static code and a dynamic code according to time when the code is driven. For example, in a code-programmed network node, a code is divided into a static code when the code is always driven. In a code-installed network node, a code is divided into a dynamic code when the code is driven according to a specific condition.

A code is divided into a synchronous code and an asynchronous code according to timing when the code is driven. For example, in code-installed network nodes, a code is divided into a synchronous code when the driving timings of a code are synchronized. In code-installed network nodes, a code is divided into an asynchronous code when the driving timings of the code are not synchronized.

Exemplarily, a static code is always driven in the network nodes 100. Accordingly, the static code may be regarded as a synchronous code. The dynamic code may be divided into one of a synchronous code and an asynchronous code.

A code is divided into a real time code and a non-real time code according to the time limit of installation. For example, when a code to be programmed is generated (for example, received) and the generated (for example, received) code should be programmed in the network nodes 100 within a reference time, the generated (for example, received) code is divided into a real time code. When a code to be programmed is generated (for example, received) and there is no limit of time when the generated (for example, received) code should be installed, the generated (for example, received) code is divided into a non-real time code.

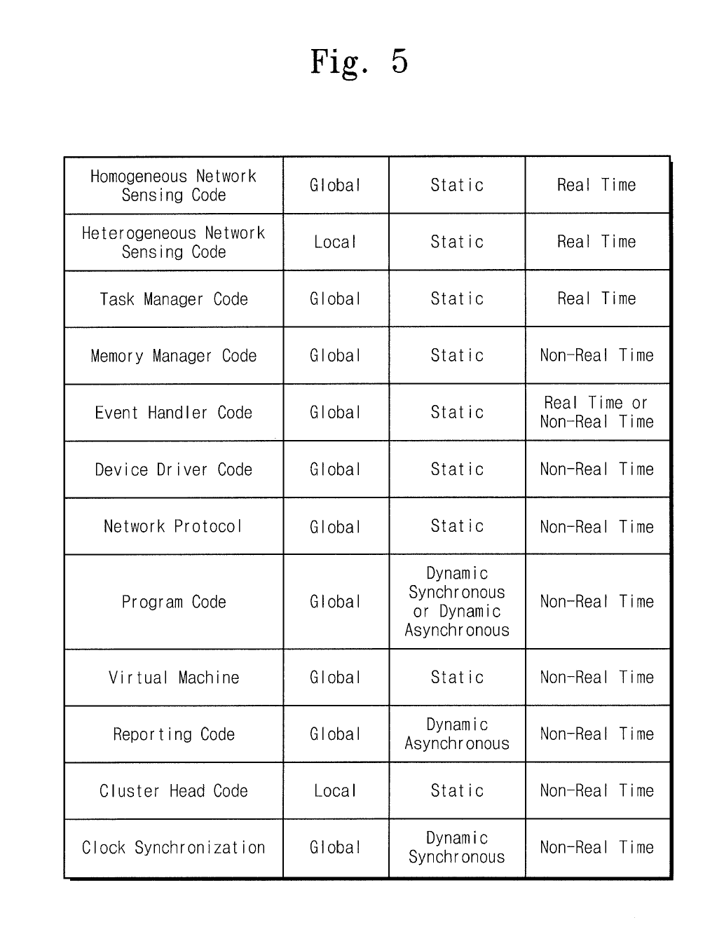

FIG. 5 is a table showing an embodiment of division based on the kinds of codes in FIG. 4.

Referring to FIGS. 3 through 5, the sensing code of a homogeneous network is divided into a global code, a static code and a real time code. The sensing code of a heterogeneous network is divided into a local code, a static code and a real time code. That is, the sensing code may be divided into a global code or a local code according to whether the network nodes 100 of the sensor network 10 are configured with a homogeneous code or a heterogeneous code.

A task manager code is divided into a global code and a real time code. The memory manager code is divided into a global code and a non-real time code. An event handler code is divided into a global code and a real time code or a non-real time code. A device manager code is divided into a global code, a static code and a non-real time code. That is, among management codes for managing the network node 100, a code associated with an external operation (for example, sensing and communication) is divided into a real time code. Among management codes for managing the network node 100, a code associated with an internal operation (for example, memory management and device management) is divided into a non-real time code.

For example, a task manager code for controlling a sensing operation and a communication operation may be divided into a real time code. For example, a memory manager code for managing the memory of the network node 100 and a device driver code for managing devices such as the sensing unit 140 (see FIG. 1) and the communication unit 150 may be divided into a non-real time code.

For example, when an event handler code is set to manage only the internal event of the network node 100, it may be divided into a non-real time code. For example, when an event handler code is set to manage the external event (for example, metadata reception) of the network node 100, it may be divided into a real time code.

Likewise, a network protocol is divided into a global code, a static code and a non-real time code. A program code is divided into a global code, a dynamic synchronous or dynamic asynchronous code, and a non-real time code. A virtual machine is divided into a global code, a dynamic asynchronous code, and a real time code. A cluster head code is divided into a local code, a static code, and a non-real time code. Clock synchronization is divided into a global code, a dynamic synchronous code, and a non-real time code.

Code division in FIG. 5 is an exemplary example. It can be understood that code division may be modified and applied according to the purposes of codes to be programmed.

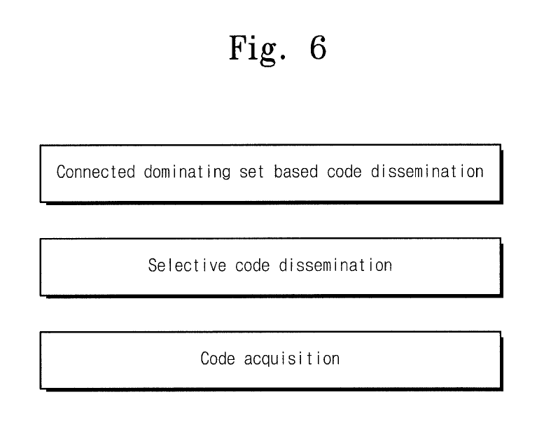

FIG. 6 is a block diagram illustrating programming schemes according to an embodiment of the present invention.

Referring to FIG. 6, programming schemes include a Connected Dominating Set (CDS)-based code dissemination scheme, a selective code dissemination scheme, and a code acquisition scheme. That is, when a code to be programmed is generated (for example, received), any one of the CDS-based code dissemination scheme, the selective code dissemination scheme and the code acquisition scheme is selected as a programming scheme.

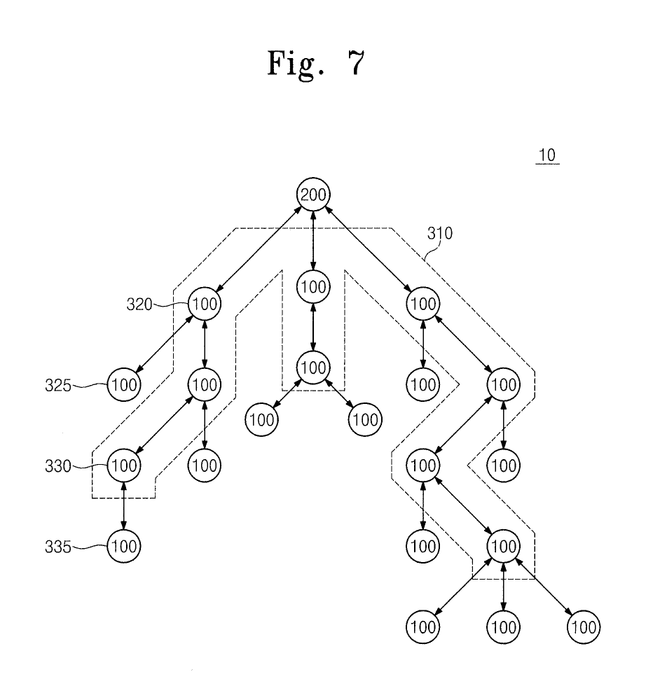

FIG. 7 is a block diagram illustrating the CDS of the sensor network 10 in FIG. 2.

Referring to FIG. 7, a CDS is configured with a plurality of network nodes 100. Hereinafter, network nodes configuring the CDS are called CDS nodes.

The CDS nodes configure one group 310, i.e., a CDS. A CDS 310 is connected to a sink node 200. The neighbor nodes (for example, reference numerals 325 and 335) of CDS nodes (for example, reference numerals 320 and 330) are not included in the CDS 310. All the network nodes 100 of the sensor network 10 should be set as CDS nodes or the neighbor nodes of the CDS nodes. At this point, the group 310 of the CDS nodes is as illustrated in FIG. 7.

The sink node 200 broadcasts (for example, floods) a code to be programmed to the CDS nodes. The CDS nodes receive the broadcasted code, and again broadcast the received code. It is prohibited that the neighbor nodes (for example reference numerals 325 and 335) of the CDS nodes broadcasts the received code. That is, the broadcasting of a code is limited in order to be performed only in the CDS nodes. Since the number of times a code is broadcasted decreases, power consumption and traffic load dependent on code broadcasting decrease.

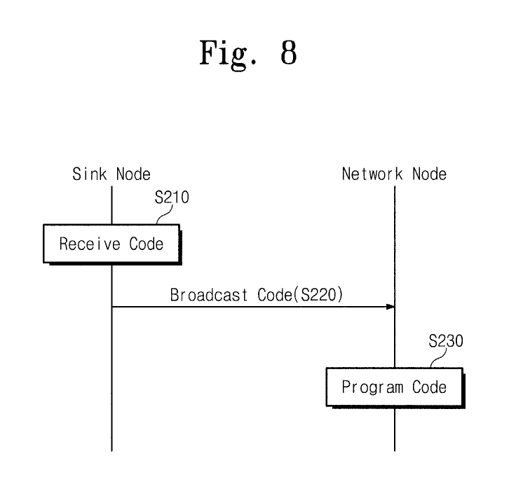

FIG. 8 is a flow chart illustrating the CDS-based code dissemination scheme in FIG. 6.

Referring to FIGS. 7 and 8, the sink node 200 receives a code to be programmed in operation S210. The sink node 200 broadcasts a received code. For example, the sink node 200 broadcasts a received code through the CDS-based code dissemination scheme.

The network node 100 receives a code in operation S230. The network node 100 programs the received code. For example, when the network node 100 is a CDS node, the network node 100 again broadcasts the received code. When the network node 100 is the neighbor node of the CDS node, the network node 100 does not again broadcast the received code.

According to the CDS-based code dissemination scheme, as described above, the received code is broadcasted when a code is received. That is, an operation of broadcasting the metadata of the received code is not separately required. Accordingly, the power consumption and traffic load of the sensor network 10 decreases. Moreover, since only CDS nodes may again broadcast a received node by limit, power consumption and traffic load decrease.

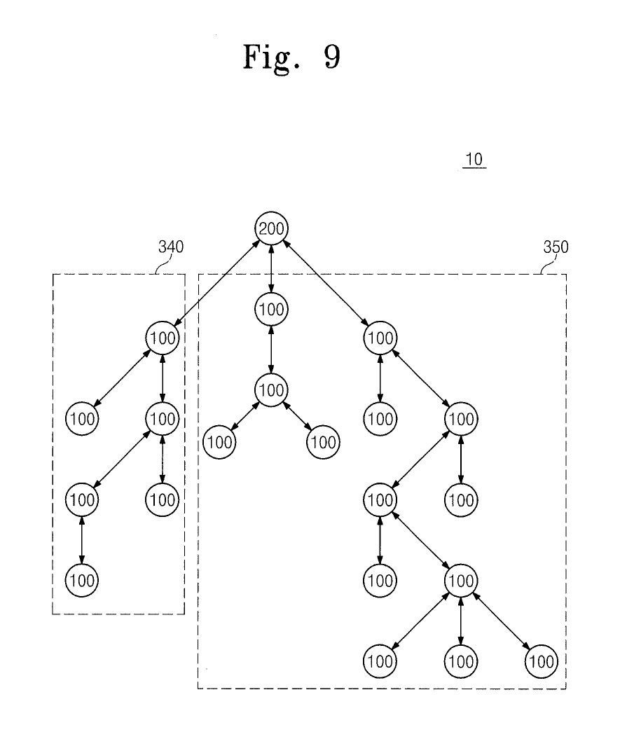

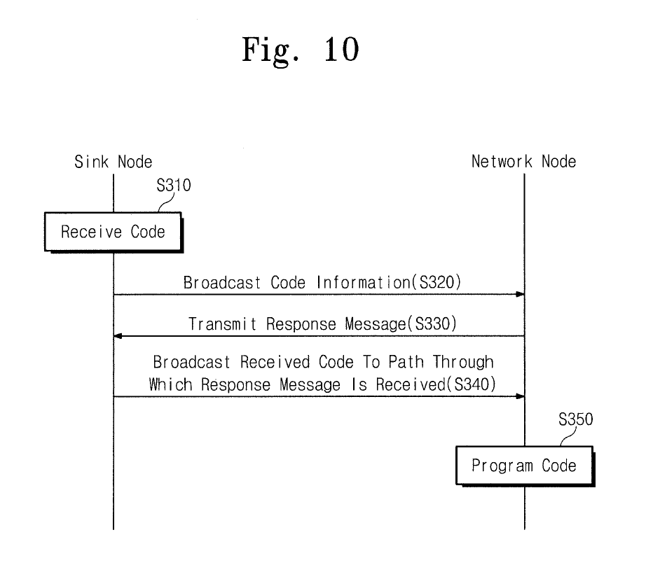

FIG. 9 is a block diagram illustrating the first and second groups 340 and 350 of the network nodes 100 of the sensor network 10 in FIG. 1. FIG. 10 is a flow chart for describing the selective code dissemination scheme in FIG. 6.

Referring to FIGS. 9 and 10, the sink node 100 receives a code to be programmed in operation S310. After the code to be programmed is received, the sink node 200 broadcasts the code information of the received code in operation S320. For example, the sink node 200 broadcasts the metadata of the received code. For example, code information (or metadata) is broadcasted based on the CDS that has been described above with reference to FIGS. 7 and 8.

Response messages are transmitted from the network nodes 100 in operation S330. Exemplarily, it is assumed that response messages are not received from the network nodes 100 corresponding to the first group 340 of the network nodes 100 of the sensor network 10 and are received from the network nodes 100 corresponding to a second group 350.

The sink node 200 broadcasts the received code to a path through which the response message is received in operation S340. That is, the sink node 200 broadcasts the received code to the network nodes 100 corresponding to the second group 350. For example, the sink node 200 broadcasts the received code to network nodes corresponding to the second group 350 through flooding.

A code is programmed in the network nodes 100 receiving it in operation S350. That is, a code is programmed in the network nodes 100 corresponding to the second group 350.

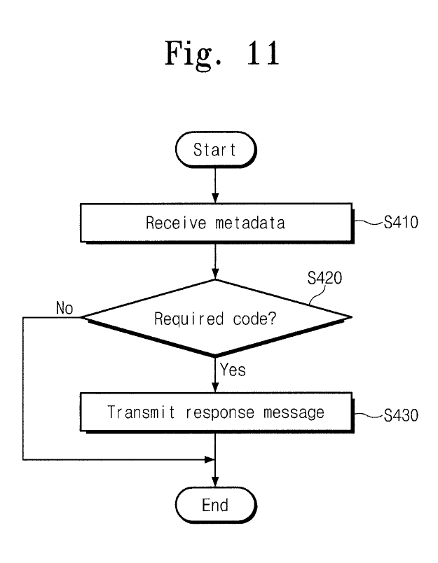

FIG. 11 is a flow chart for describing an operation of the network node 100 when the selective code dissemination scheme is performed.

Referring to FIG. 11, the network node 100 receives code information (or metadata) in operation S410. As described above with reference to FIGS. 9 and 10, code information (or metadata) is broadcasted from the sink node 200 when a code to be programmed is generated.

The network node 100 determines whether a code corresponding to received code information is a code that is required in the network node 100 in operation S420. That is, the network node 100 determines whether a code corresponding to received code information is a code that should be programmed in the network node 100.

For example, the network node 100 compares the received code information and codes that are installed in the network node 100. When the received code information represents one new version among codes that are installed in the network node 100, the network node 100 determines a code corresponding to the received code information as a code that is required in the network node 100. That is, the network node 100 determines the code corresponding to the received code information as an update code in which a code updates the existing code.

For example, when there is no code corresponding to the received code information among codes that are installed in the network node 100 and the received code information is information related to the network node 100, the network node 100 determines the code corresponding to the received code information as a code that is required in the network node 100. That is, the network node 100 determines the code corresponding to the receive code information as a code that should be newly installed.

When the code corresponding to the received code information is a code that is required in the network node 100, the network node 100 transmits a response message. For example, the network node 100 transmits the response message to the sink node 200. When the code corresponding to the received code information is not a code that is required in the network node 100, the response message is not transmitted. Exemplarily, when the code corresponding to the received code information is not a code that is required in the network node 100, the network node 100, it should be understood that the network node 100 may be applied in order to transmit a message indicating that a code is not required.

As described above, when a code is programmed in the selective code dissemination scheme, the network nodes 100 are determined which require a code based on the broadcasting of code information (or metadata). A code is broadcasted only to the network nodes 100 requiring it. Since the number of times a code is transmitted decreases, power consumption and traffic load can decrease.

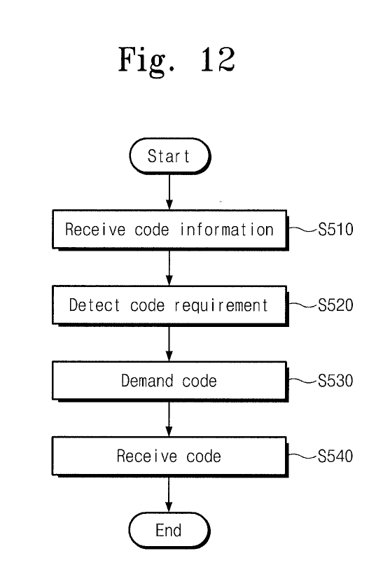

FIG. 12 is a flow chart for describing the code acquisition scheme in FIG. 6.

Referring to FIG. 12, the network node 100 receives code information (or metadata) in operation S510. Exemplarily, when a code to be programmed is generated (or received) and a code to be programmed is determined as being programmed through the code acquisition scheme, the sink node 200 broadcasts code information (or metadata) corresponding to the code to be programmed. For example, the sink node 200 broadcasts code information (or metadata) based on the CDS. Based on the broadcasted code information (or metadata), the network node 100 can recognize that a code to be programmed is generated.

The network node 100 detects code requirement in operation 5520. That is, the network node 100 detects whether a code corresponding to the received code information (or metadata) is required in the network node 100. For example, when a code corresponding to the received code information (or metadata) should be driven in the network node 100, the network node 100 determines that a code corresponding to the received code information (or metadata) is required.

The network node 100 demands a code in operation S530. For example, based on code requirement that is detected, the network node 100 transmits code demand. For example, based on code requirement that is detected, the network node 100 transmits code demand to the sink node 200.

When code demand is received from the network node 100, the sink node 200 transmits a code corresponding to the received code demand to the network node 100 corresponding to the received code demand.

The network node 100 receives the transmitted code in operation S540. For example, the network node 100 receives the code that is transmitted from the sink node 200. The received code is programmed in the network node 100.

As described above, when a code to be programmed is required, the network nodes 100 demand the code to be programmed. The demanded code is transmitted from the sink node 200 to the network node 100. Since on-demand code transmission is performed, the number of times a code is transmitted is minimized. Accordingly, power consumption and traffic load can decrease when programming a code.

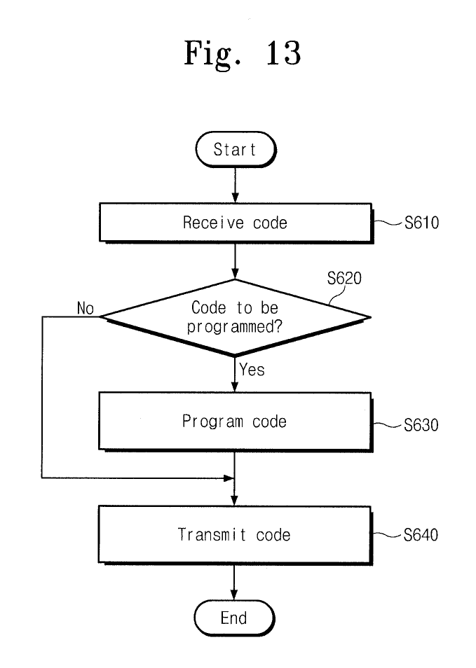

FIG. 13 is a flow chart for describing an operation of the network node 100 which relays a code when the code acquisition scheme in FIG. 12 is performed.

Referring to FIG. 13, a code is received in operation S610.

The received code is determined whether it is a code that should be programmed in the network node 100 in operation S620. When the received code is determined as a code that should be programmed, the received code is programmed in the network node 100 in operation S630. Subsequently, the received code is transmitted in operation S640. When the received code is determined as not being a code that should be programmed, code programming is not performed in operation S630. Afterwards, the received code is transmitted in operation S640.

That is, when a code is transmitted in response to the code demand of a specific network node 100 and a code is required in at least one of the network nodes 100 on a path through which a code is transmitted, a code is programmed in at least one network node 100 requiring a code. For example, when a code is programmed in the code acquisition scheme, the transmitted code is programmed in the network nodes that should program transmitted codes among the network nodes 100 on a path through which a code is transmitted.

That is, irrespective of whether the network nodes 100 on the path generates (or transmits) code demand, when a code is programmed in the network node 100 that generates the code demand, the network nodes 100 on the path through which a code is transmitted may be programmed together. Accordingly, when a code is programmed in the network node 100 that generates code demand, the network nodes 100 on a code transmission path may be additionally programmed without separate power consumption and traffic load.

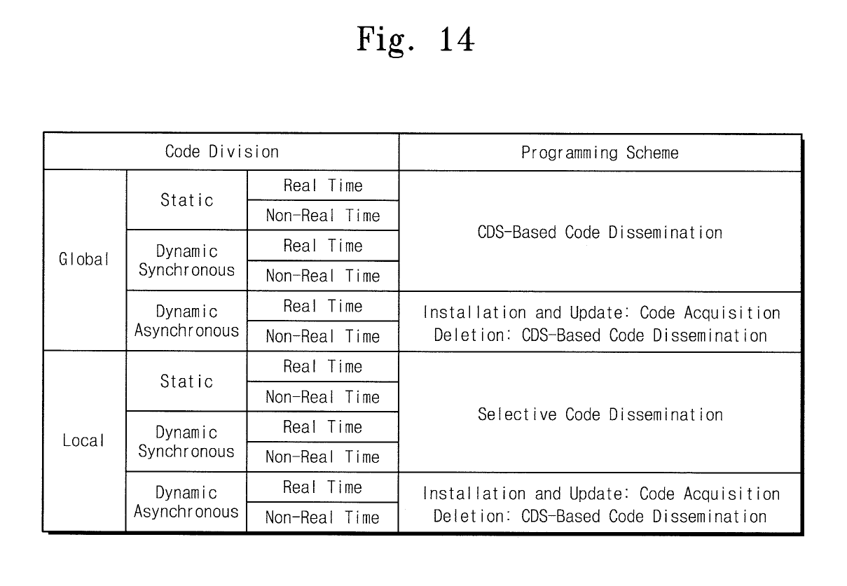

FIG. 14 is a table for describing a programming scheme which is selected based on the kinds of codes in FIG. 4.

Referring to FIG. 14, when a code to be programmed is a global and static or dynamic synchronous code, the CDS-based code dissemination scheme is selected as a programming scheme.

A global and static code is required in all the network nodes 100 of the sensor network 10 and is always driven in network nodes that are installed. A global and dynamic synchronous code is required in all the network nodes 100 of the sensor network 10 and is always driven in network nodes that are installed. That is, a global and static code or a global and dynamic synchronous code is simultaneously performed in all the network nodes 100 of the sensor network 10. Accordingly, the CDS-based code dissemination scheme is selected which broadcasts a code to all the network nodes 100 of the sensor network 10 to perform programming.

When a code to be programmed is a local and static or dynamic synchronous code, the selective code dissemination scheme is selected. A local and static code is required in a portion of the network nodes 100 of the sensor network 10 and is always (i.e., simultaneously) driven in network nodes that are installed. A local and dynamic synchronous code is required in a portion of the network nodes 100 of the sensor network 10 and is simultaneously driven in network nodes that are installed. That is, a local and static or local and dynamic synchronous code is simultaneously performed in a portion of the network nodes 100 of the sensor network 10. Accordingly, the selective code dissemination scheme is selected which broadcasts a code to a portion of the network nodes 100 of the sensor network 10 to perform programming.

When a code to be programmed is a dynamic synchronous code, the installation and deletion of a code is performed in the code acquisition scheme, and the deletion of a code is performed in the CDS-based code dissemination scheme. A dynamic asynchronous code is driven when a specific condition is satisfied in the network nodes 100. That is, when a network node that satisfies the specific condition among the network nodes 100 is not generated, a code to be programmed need not be programmed in the network nodes 100. Accordingly, when a code to be programmed is a dynamic asynchronous code, the code acquisition scheme for programming an on-demand code is selected.

When a code to be programmed responds to the deletion message of a specific code, it is broadcasted to all the network nodes 100 through the CDS-based code dissemination scheme. Accordingly, an error and a load, which occur because a code to be deleted is driven, are prevented.

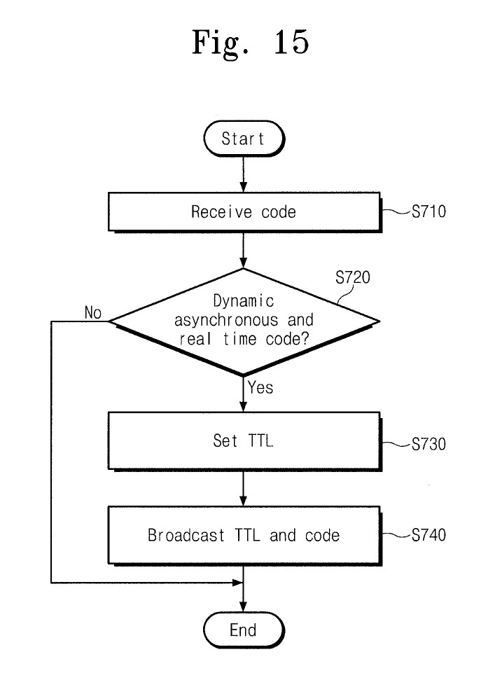

FIG. 15 is a flow chart for describing an operation in which the sink node 200 sets cache information when a code to be programmed is a dynamic asynchronous and real time code.

Referring to FIG. 15, a code to be programmed is received in operation S710. The sink node 200 determines whether the received code is a dynamic asynchronous and real time code in operation S720. When the received code is not the dynamic asynchronous and real time code, the sink node 200 terminates an operation for setting cache information. When the received code is the dynamic asynchronous and real time code, operation S730 is performed.

The sink node 2000 sets Time To Live (TTL) in operation S730. Subsequently, the sink node 200 broadcasts TTL and the received code in operation S740. For example, TTL and the received code are broadcasted through the CDS-based code dissemination scheme or the selective dissemination scheme, according to whether the received code is a global code or a local code.

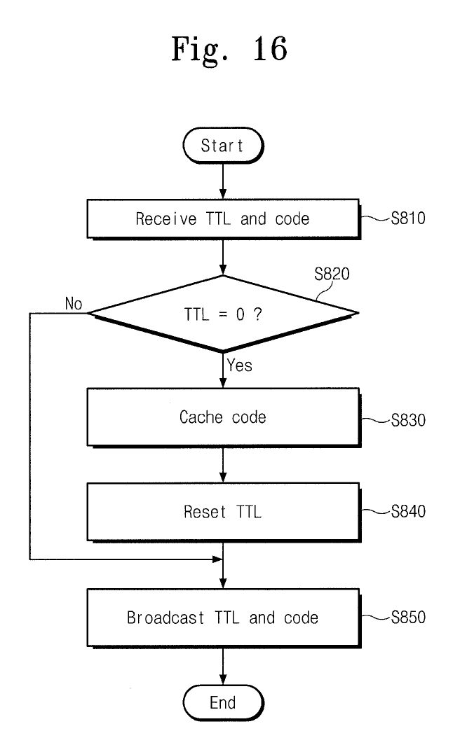

FIG. 16 is a flow chart for describing an operation in which the network node 100 caches a code when a code to be programmed is a dynamic asynchronous and real time code.

Referring to FIG. 16, the network node 100 receives TTL and a code in operation 5810.

The network node 100 determines whether a TTL value is ‘0’ in operation 5820. When the TTL value is not ‘0’, operation S850 is performed. When the TTL value is ‘0’, operation 5830 is performed.

The network node 100 caches the received code in operation 5830. That is, the network node 100 stores the received code. For example, the network node 100 may store the received code in the memory 130 in FIG. 1. That is, the network node 100 is set as a cache node.

The network node 100 resets TTL in operation S840. At this point, the TTL value may be reset as the initial value that is set in operation S730 of FIG. 15. Subsequently, operation 5850 is performed.

The network node 100 broadcasts TTL and the received code in operation 5850. For example, when the network node 100 is the neighbor node of a CDS node, it may not broadcast TTL and the received code.

Exemplarily, when a code is transmitted in the network nodes 100 of the sensor network 10, average delay per hop is defined as ‘L’. Furthermore, the number of hops between the network node 100 (hereinafter referred to as a demand node) transmitting code demand and a cache node is defined as ‘N’. At this point, time (hereinafter referred to as a demand and reception time) until the first packet is transmitted from a cache node to a demand node after the demand node demands a code is defined as ‘2LN’. The demand and reception time includes time when code demand is transferred from the demand node to the cache node and time when the first packet is transferred from the cache node to the demand node.

It is assumed that a code which is cached in the cache node is configured with an M number of packets. For preventing collision between a packet that is transmitted at a specific time and a subsequent packet, the packet that is transmitted at the specific time is transmitted from the cache node to the third lower node (for example, a three-hop distance node) and the subsequent packet is transmitted. Such delay (hereinafter referred to as collision prevention delay) is not applied to the first packet of the cached code. Accordingly, collision prevention delay may be defined as ‘3L(M−1).

By summing the demand and reception time ‘2LN’ and the collision prevention delay ‘3L(M−1)’, total delay is calculated. Total delay is defined as “2LN+3L(M−1)”.

A real time code is demanded and should be programmed in a target network node 100 within a reference time. Accordingly, when the number ‘N’ of hops between the cache node and the demand node is set so that total delay may be shorter than the reference time, the real-time programming of the real time code may be performed.

Exemplarily, a reference time is defined as ‘D’. Based on total delay and the reference time ‘D’, Equation (1) is defined.

N=(D−3L(M−1))/2L (1)

The reference time ‘D’ may be detected from a code to be programmed. Average delay per hop may be detected from the sensor network 10. The number ‘M’ of packets in a code to be programmed may be detected from the code to be programmed. That is, when a code to be programmed is generated (for example, received), the number ‘N’ of hops may be calculated. Exemplarily, an integer portion of the calculated number ‘N’ of hops may represent the maximum number ‘Nmax’ of hops between the demand node and the cache node.

As described above with reference to FIG. 15, based on the calculated maximum number ‘Nmax’ of hops, the sink node 200 sets TTL. Exemplarily, the sink node 200 sets TTL to ‘Nmax−1’. When TTL is set to ‘Nmax−1’, the distance between the cache nodes is set to ‘Nmax−1’ in the sensor network 10. That is, the distance between the specific network node 100 of the sensor network 10 and a cache node nearest to the specific network node 100 is maintained as a value equal to or less than ‘Nmax−1’. Therefore, a real time code may be programmed in the network nodes 100 within the reference time.

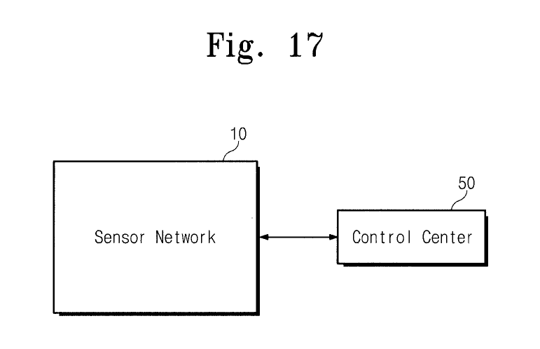

FIG. 17 illustrates an embodiment of a sensor system including the sensor network 10 in FIG. 2.

Referring to FIG. 17, a sensor system according to an embodiment of the present invention includes a sensor network 10 and a control center 50. The sensor network 10 operates, simultaneously with the described in FIGS. 1 through 16.

The control center 50 collects a sensing result from the sensor network 10. For example, based on the sensing result that is collected from the sensor network 10, the control center 50 may detect in real time an area corresponding to the sensor network 10. For example, based on the sensing result that is collected from the sensor network 10, the control center 50 may detect whether events such as crimes, disasters, accidents and border disputes occur in the area corresponding to the sensor network 10. For example, based on the sensing result collected from the sensor network 10, the control center 50 may acquire information such as the weather, parking and lighting control circumstances of the area corresponding to the sensor network 10.

Exemplarily, two or more sensor networks may be connected to the control center 50. The control center 50 may detect in real time areas corresponding to the two or more sensor networks.

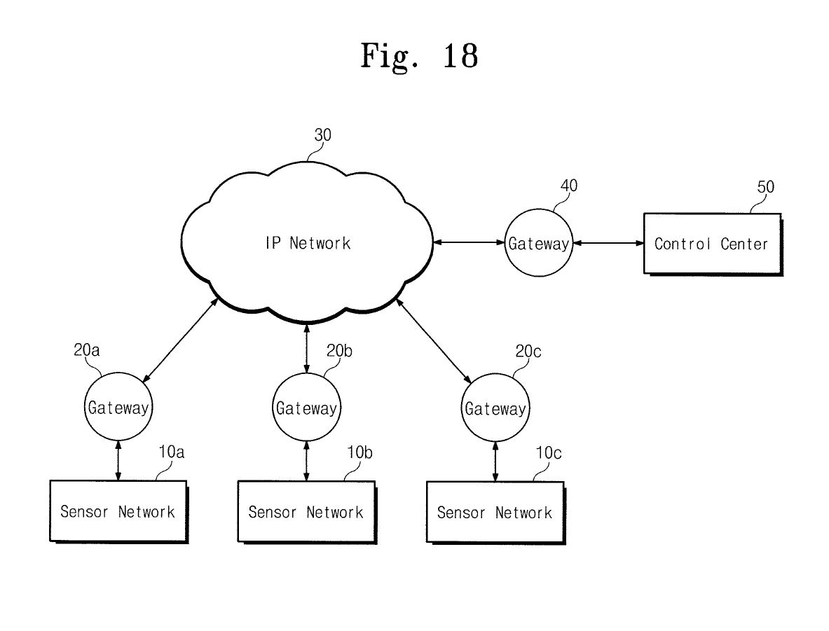

FIG. 18 illustrates another embodiment of a sensor system including the sensor network 10 in FIG. 2.

Referring to FIG. 18, a sensor system according to another embodiment of the present invention includes sensor networks 10a to 10c, gateways 20a to 20c and 40, an Internet Protocol (IP) network 30, and a control center 50.

Each of the sensor networks 10a to 10c operates, simultaneously with the described in FIGS. 1 through 16. The sensor networks 10a to 10c are connected to the gateways 20a to 20c corresponding to them, respectively. The sensor networks 10a to 10c are connected to the IP network 30 through the gateways 20a to 20c, the sensor, respectively. The control center 50 is also connected to the IP network 30 through the gateway 40.

The control center 50 collects sensing results from the sensor networks 10a to 10c. For example, the sensing results of the sensor networks 10a to 10c may be transferred to the IP network 30 through the gateways 20a to 20c corresponding to them. The sensing results may be transferred from the IP network 30 to the gateway 40 that is connected to the control center 50. Furthermore, the control center 50 receives the sensing results of the sensor networks 10a to 10c from the gateway 40.

Based on the sensing results collected from the sensor networks 10a to 10c, the control center 50 detects areas corresponding to the sensor networks 10a to 10c. For example, based on the sensing results collected from the sensor networks 10a to 10c, the control center 50 may detect whether events such as crimes, disasters, accidents and border disputes occur in the areas corresponding to the sensor networks 10a to 10c. For example, based on the sensing results collected from the sensor networks 10a to 10c, the control center 50 may acquire information such as the weather, parking and lighting control circumstances of the areas corresponding to the sensor networks 10a to 10c.

The sensor networks 10a to 10c are connected to the IP network 30, and thus the control center 50 can perform wide-area detection based on the sensor networks 10a to 10c. For example, the control center 50 may detect in real time areas corresponding to eup, myeon, dong, gu, gun, si, do or nation units.

Exemplarily, the sensor networks 10a to 10c are connected to the IP network 30 through a satellite. When the sensor networks 10a to 10c are connected to the IP network 30 through the satellite, it can be understood that isolation areas such as islands, mountains, branch offices in foreign countries and diplomatic offices in foreign countries may be detected.

According to embodiments of the present invention, a programming scheme is selected according to the kinds of codes. That is, code programming based on the kinds of codes is performed. Accordingly, power consumption and traffic load decrease when programming a code.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A programming method of network nodes in a sensor network, the programming method comprising:
receiving a code to be programmed into the network nodes;
determining a kind of the received code;
selecting a programming scheme according to the determined kind of the code; and
programming the received code into the network nodes based on the selected programming scheme.

2. The programming method of claim 1, wherein the determining of the kind of the received code comprises determining whether the received code is required in all the network nodes of the sensor network.

3. The programming method of claim 1, wherein the determining of the kind of the received code comprises determining whether the received code is a code that is always driven.

4. The programming method of claim 1, wherein the determining of the kind of the received code comprises determining whether driving timings of the received code are synchronized.

5. The programming method of claim 1, wherein the determining of the kind of the received code comprises determining whether the received code is installed within a reference time.

6. The programming method of claim 1, wherein the selecting of a programming scheme comprises selecting a code dissemination scheme.

7. The programming method of claim 6, wherein the programming of the received code comprises performing the selected code dissemination scheme based on a connected dominating set.

8. The programming method of claim 1, wherein the selecting of a programming scheme comprises selecting a selective code dissemination scheme.

9. The programming method of claim 8, wherein the programming of the received code comprises:
transmitting information of the received code to the network nodes;
transmitting the received code to selected network nodes, which transmit a response signal corresponding to the transmitted information of the received code, among the network nodes; and
programming the transmitted code into the selected network nodes.

10. The programming method of claim 1, wherein the selecting of a programming scheme comprises selecting a code acquisition scheme.

11. The programming method of claim 10, wherein the programming of the received code comprises:
transmitting the received code to a network node which transmits code demand among the network nodes; and
programming the transmitted code into a corresponding network node.

12. The programming method of claim 11, wherein the programming of the received code further comprises programming the transmitted code into at least one network node, when the transmitted code is required in the at least one network node of network nodes on a path through which the transmitted code is transmitted.

13. The programming method of claim 1, wherein when the received code is required in all the network nodes of the sensor network and driving timings of the received code are synchronized, the received code is programmed into all the network nodes through a code dissemination scheme.

14. The programming method of claim 1, wherein when the received code is required in a portion of the network nodes and driving timings of the received code are synchronized, code information of the received code is transmitted to the network nodes, and the received code is programmed into network nodes which respond to the transmitted code information.

15. The programming method of claim 1, wherein when driving timings of the received code are not synchronized, the received code is programmed into a network node which demands the received code among the network nodes.

16. The programming method of claim 15, wherein when driving timings of the received code are not synchronized and the received code is installed within a reference time, the received code is stored in some network nodes among the network nodes, the stored code is transmitted from the some network nodes to a network node demanding the received code and is programmed.

17. An operating method of sensor network, comprising:
receiving a code to be programmed into network nodes of the sensor network;
detecting a kind information of the received code; and
programming the received code into the network nodes based on the detected kind information.

18. The operating method of claim 17, wherein the programming of the received code comprises:
selecting a programming scheme based on the detected kind information; and
programming the received code into the network nodes based on the selected programming scheme.

19. The operating method of claim 18, wherein the selecting of a programming scheme comprises selecting any one of a first programming scheme which programs the received code into the network nodes, a second programming scheme which programs the received code into network nodes responding to metadata transmission of the received code among the network nodes, and a third programming scheme which programs the received code into a network node demanding the received code among the network nodes.

20. The operating method of claim 18, wherein the selecting of a programming scheme comprises selecting the programming scheme based on whether the received code is required in all the network nodes of the sensor network, whether the received code is always driven, whether driving timings of the received code are synchronized and whether the received code is installed within a reference time.
